(19) United States
(12) Patent Application Publication
(10) Pub. No.: US 2008/0218149 A1
(43) Pub. Date: Sep. 11, 2008

(54) DISPLAY DEVICE

(76) Inventors: Yoshinori Aoki, Mobara (JP); Mitsuru Goto, Yokohama (JP); Yoshihiro Kotani, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/873,017

(22) Filed: Oct. 16, 2007

(30) Foreign Application Priority Data
Oct. 16, 2006 (JP) 2006-280853

(51) Int. Cl. H02M 3/156

(52) U.S. Cl. 323/351

(57) ABSTRACT

The present invention is intended to minimize an amount of charge that flows from a step-up circuit into an external input voltage terminal when the power supply is turned off. A display device includes a display panel and a drive circuit that drives pixels included in the display panel. The drive circuit includes a power circuit to which a voltage Vcc is fed. The power circuit includes: a first step-up circuit that generates a voltage DDVDH which is higher than the voltage Vcc; a means 1 that when the first step-up circuit is de-energized, connects the voltage DDVDH output terminal of the first step-up circuit to a reference voltage terminal via a resistive element during a first period; and a means 2 that connects the voltage DDVDH output terminal of the first step-up circuit to an input terminal, to which the voltage Vcc is fed, during a second period succeeding the first period.

The present application claims priority from Japanese application JP2006-280853 filed on Oct. 16, 2006, the content of which is hereby incorporated by reference into this application.

### BACKGROUND OF THE INVENTION

1. Field of the Invention

The present invention relates to a display device, or more particularly, to a technology proved effective in turning off the power supply of a display device.

2. Description of the Related Art

Thin-film transistor (TFT) liquid crystal display modules including a compact liquid crystal display panel have been widely adopted as display units for portable cellular phones, digital cameras, and so on.

The compact liquid crystal display module has a power circuit incorporated therein. In the power circuit, a charge pumping type step-up circuit generates a high-potential voltage, which is needed to drive a liquid crystal display panel, from an externally-fed voltage Vcc (refer to patent document 1 (JP-A-2005-351921) (associated with U.S. Patent Application No. US2005/0270009A1)).

The high-potential voltage includes, for example, a gate-on voltage (VGH) which is applied to the gate of a thin-film transistor in order to turn on the thin-film transistor, and a voltage (DDVDH) needed to generate a gray-level voltage which is applied to a liquid crystal.

In the above liquid crystal display module, when the power supply is turned off, the step-up circuit stops.

FIG. 10 is an explanatory diagram concerning an off sequence implemented in a conventional liquid crystal display module.

As shown in FIG. 10, according to the conventional off sequence, when a step-up circuit stops at a time instant t11, a voltage DDVDH output terminal of the step-up circuit is connected to a voltage Vcc input terminal of the power circuit. Thus, the voltage DDVDH is released to the voltage Vcc input terminal.

Moreover, a voltage VGH output terminal of the step-up circuit is connected to the voltage DDVDH output terminal of the step-up circuit via a resistive element during a period T11. Thereafter, during a period T12, the voltage VGH output terminal is directly connected to the voltage-DDVDH output terminal of the step-up circuit during a period T12. Thus, the voltage VGH is released to the voltage Vcc input terminal.

As mentioned above, according to the conventional off sequence, the voltage VGH and voltage DDVDH are released to the voltage Vcc input terminal. Consequently, when the step-up circuit stops, charge flows into the voltage Vcc input terminal. This may cause the voltage Vcc to rise and may adversely affect the other ICs.

For prevention of the above incident, after a step-up magnification set in the step-up circuit is decreased, the step-up circuit has to be stopped. This necessitates a signal to be sent from a timing controller. Consequently, the time required for stopping the liquid crystal display module increases. When a battery pack is removed, the liquid crystal display module may not be able to be stopped.

### SUMMARY OF THE INVENTION

The present invention addresses the problem underlying the related art. An object of the present invention is to provide a technology for making it possible to minimize an amount of charge, which flows from a step-up circuit to an external input voltage terminal, when the power supply of a display device is turned off.

The object of the present invention, the other objects thereof, and novel features thereof will be apparent from the description in the present specification and the appended drawings.

A display device in accordance with a typical aspect of the present invention will be outlined below.

A display device includes a display panel and a drive circuit that drives pixels included in the display panel. The drive circuit includes a power circuit to which a voltage Vcc is supplied. The power circuit includes a first step-up circuit that generates a voltage DDVDH which is higher than the voltage Vcc, a means 1 that when the first step-up circuit is de-energized, connects a voltage DDVDH output terminal of the first step-up circuit to a reference voltage terminal via a resistive element during a first period, and a means 2 that connects the voltage DDVDH output terminal of the first step-up circuit to an input terminal, to which the voltage Vcc is applied, during a second period succeeding the first period.

An advantage provided by the typical aspect of the present invention will be described below.

According to the present invention, when the power supply of the display device is turned off, an amount of charge that flows from a step-up circuit to an external input voltage terminal can be minimized.

### BRIEF DESCRIPTION OF THE DRAWINGS

FIG. 1 is a block diagram showing the outline configuration of a liquid crystal display module in accordance with an embodiment of the present invention;

FIG. 2 is a block diagram showing the internal configuration of a power circuit 120 shown in FIG. 1;

FIG. 3 is an explanatory diagram concerning an off sequence implemented in the liquid crystal display module in accordance with the embodiment of the present invention;

FIG. 4 is a circuit diagram showing the circuitry for releasing a voltage DDVDH in the embodiment of the present invention;

FIG. 5 is a circuit diagram showing the circuitry for generating a control signal A and a control signal B which are shown in FIG. 4;

FIG. 6 shows a truth table relevant to the circuit shown in FIG. 5;

FIG. 7 is a circuit diagram showing the circuitry for releasing a voltage VGH in the embodiment of the present invention;

FIG. 8 is a circuit diagram showing the circuitry for generating a control signal C and a control signal D which are shown in FIG. 7;

FIG. 9 shows a truth table relevant to the circuit shown in FIG. 8; and

FIG. 10 is an explanatory diagram concerning an off sequence implemented in a conventional liquid crystal display module.

### DESCRIPTION OF THE PREFERRED EMBODIMENT

Referring to the drawings, an embodiment of the present invention will be described below.

In all the drawings which will be referred to in the course of describing the embodiment, the same reference numerals or symbols will be assigned to components having the same capabilities. An iterative description will be omitted.

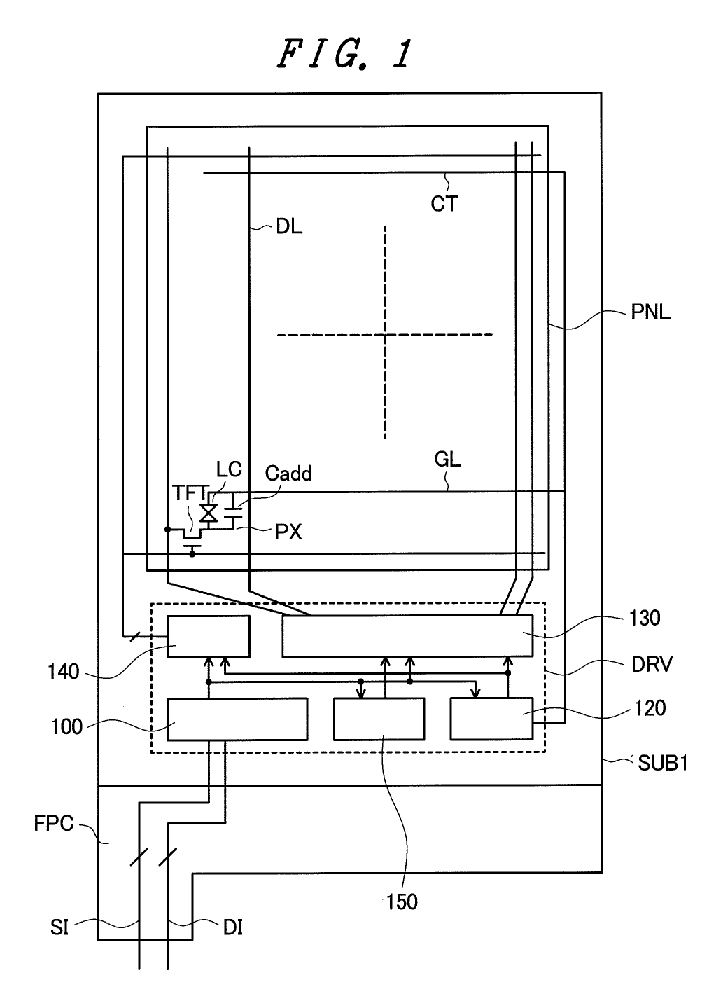

FIG. 1 is a block diagram showing the outline configuration of a liquid crystal display module in accordance with an embodiment of the present invention. In the drawing, there are shown a control circuit 100, a power circuit 120, a source driver 130, a gate driver 140, a memory circuit 150, a liquid crystal display panel PNL, a video line (source line or drain line) DL, a scanning line (or gate line) GL, a thin-film transistor (TFT), a pixel electrode PX, an opposite electrode (common electrode) CT, a liquid crystal capacity LC, a retentive capacity Cadd, a first glass substrate SUB1, a drive circuit DRV, and a flexible printed-circuit board FPC.

Multiple scanning lines GL and multiple video lines DL are juxtaposed in the liquid crystal display panel PNL. A sub-pixel is defined at the intersection between the scanning line GL and video line DL.

Multiple sub-pixels are arranged in the form of a matrix. The pixel electrode PX and thin-film transistor TFT are disposed at each sub-pixel. In FIG. 1, the number of sub-pixels included in the liquid crystal display panel PNL comes to a product of 240 by 320 by 3.

The opposite electrode CT is formed to be opposed to each pixel electrode PX. Consequently, the liquid crystal capacity LC and retentive capacity Cadd are produced between each pixel electrode PX and opposite electrode CT.

For construction of the liquid crystal display panel PNL, the first glass substrate SUB1 on which the pixel electrodes PX and thin-film transistors TFT are formed and a second glass substrate (not shown) on which color filters or the like are formed are layered with a predetermined space between them. The glass substrates are bonded to each other with a sealing material applied to the vicinity of the perimeters of the glass substrates in the form of a frame between the glass substrates. A liquid crystal is injected into the space between the glass substrates inside the sealing material through a liquid crystal injection port formed in part of the sealing material, and then sealed. Moreover, a sheet polarizer is bonded to each of the external sides of the glass substrates.

The present invention has nothing to do with the internal structure of the liquid crystal display panel. A description of the internal structure of the liquid crystal display panel will be omitted. The present invention can be applied to any liquid crystal display panel whatever structure the liquid crystal display panel has. For example, in the case of a longitudinal electric field type, the opposite electrodes CT are formed on the second glass substrate. In the case of a lateral electric field type, the opposite electrodes CT are formed on the first glass substrate SUB1.

In the liquid crystal display module shown in FIG. 1, the drive circuit DRV is mounted on the first glass substrate SUB1.

The drive circuit DRV includes the control circuit 100, the source driver 130 that drives the video lines DL in the liquid crystal display panel PNL, the gate driver 140 that drives the scanning lines GL in the liquid crystal display panel PNL, the power circuit 120 that generates a supply voltage needed to display an image on the liquid crystal display panel PNL, and the memory circuit 150.

In FIG. 1, the drive circuit DRV is shown to be realized with one semiconductor chip. Alternatively, a thin-film transistor having a semiconductor layer made of a low-temperature polysilicon may be adopted in order to form the drive circuit DRV directly on the first glass substrate SUB1.

Likewise, some circuits included in the drive circuit DRV may be separated from one another, and the drive circuit DRV may be realized with multiple semiconductor chips. A thin-film transistor having a semiconductor layer made of a low-temperature polysilicon may be adopted in order to form some circuits included in the drive circuit DRV directly on the first glass substrate SUB1.

Further, the drive circuit DRV or some circuits included in the drive circuit DRV may be formed on a flexible printed-circuit board instead of being mounted on the first glass substrate SUB1.

Display data and a display control signal are fed from a microcontroller unit (MCU) included in a main body or a graphic controller to the control unit 100.

In FIG. 1, there is shown a system interface SI via which various control signals and image data are fed from the MCU or the like.

Reference symbol DI denotes a display data interface (RGB interface) via which image data produced by an external graphic controller and a clock for use in fetching data are successively fed (via which external data is fed).

Similarly to a drain driver to be employed in a conventional personal computer, image data is sequentially fetched via the display data interface DI synchronously with the fetching clock.

The control circuit 100 transfers image data, which is fetched via the system interface SI or display data interface DI, to each of the source driver 130 and a RAM 150.

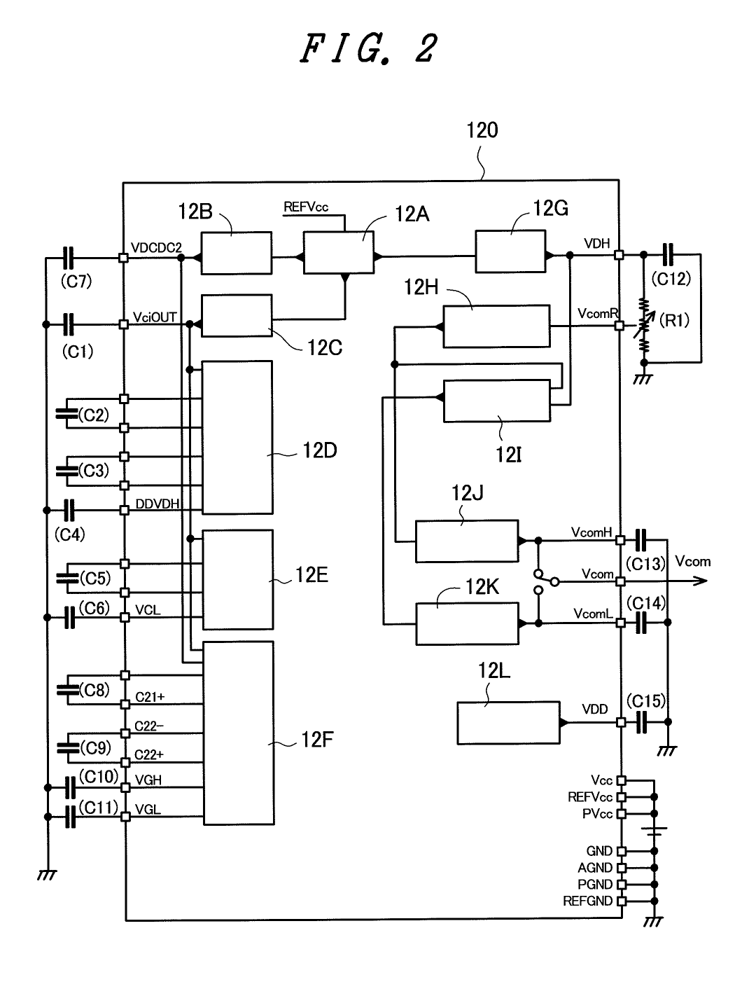

FIG. 2 is a block diagram showing the internal configuration of the power circuit 120 shown in FIG. 1.

A reference power generation circuit 12A shown in FIG. 2 generates a reference voltage, which is used to produce a step-up voltage VDCDC2 or VciOUT or a gray-level voltage VDH, from an externally-fed voltage Vcc.

A VDCDC2 output circuit 12B generates a step-up voltage VDCDC2 from the reference voltage generated by the reference power generation circuit 12A. A VciOUT output circuit 12C generates a step-up voltage VciOUT from the reference voltage generated by the reference power generation circuit 12A

A step-up circuit 1 12D generates a high-potential voltage DDVDH serving as a gray-level voltage from the step-up voltage VciOUT.

A step-up circuit 3 12E generates a voltage VCL, which is used to produce a low-level common voltage VcomL to be applied to the opposite electrodes CT, from the step-up voltage VciOUT.

A step-up circuit 2 12F generates a high-potential gate on voltage VGH and a gate off voltage VGL, which are applied to the gates of the thin-film transistors, from the step-up voltage VDCDC2 and step-up voltage VciOUT respectively.

The step-up circuit 1 12D, step-up circuit 3 12E, and step-up circuit 2 12F are realized with charge pumping type step-up circuits. Capacitors C2, C3, C5, C8, and C9 serve as step-up capacitors.

A VDH output circuit 12G generates and supplies a high-potential voltage VDH, which serves as a gray-level voltage to be applied to the liquid crystal, from the reference voltage generated by the reference power generation circuit 12A and the voltage DDVDH.

A VcomH output circuit 12J generates and supplies a high-level common voltage VcomH that is fed to the opposite electrodes CT. A VcomH level regulation circuit 12H regulates the common voltage VcomH.

A VcomL output circuit 12K generates a low-level common voltage VcomL, which is fed to the opposite electrodes CT, from the voltage VCL, and supplies the low-level common voltage VcomL. A VcomL level regulation circuit 12I regulates the voltage VcomL.

A Vdd generation circuit 12L generates a logic circuit supply voltage Vdd from the externally-fed voltage Vcc.

As mentioned above, when the power supply of the liquid crystal display module is turned off, the step-up circuit 1 12D and step-up circuit 2 12F stop.

In order to minimize an amount of charge that flows into the Vcc voltage terminal when the step-up circuit 1 12D and step-up circuit 2 12F stop, the voltage VGH and voltage DDVDH should be released to the reference voltage (that is, ground (GND)) terminal. However, the release of the voltages VGH and DDVDH to the reference voltage (GND) terminal causes a latch-up. This is not preferable.

Consequently, in the present embodiment, when the step-up circuit 1 12D and step-up circuit 2 12F stop, the voltages VGH and DDVDH are initially released to the reference voltage (GND) terminal via a resistive element. Thereafter, the voltages VGH and DDVDH are released to the voltage Vcc terminal. This major constituent feature will be described below.

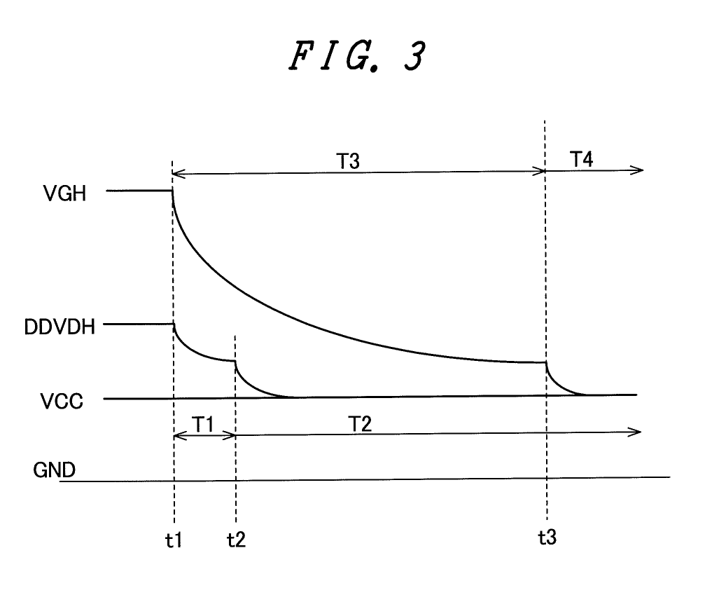

FIG. 3 is an explanatory diagram concerning an off sequence implemented in the liquid crystal display module in accordance with the present embodiment.

In the off sequence implemented in the present embodiment, when the step-up circuit 1 12D and step-up circuit 2 12F stop at a time instant t1, the voltage DDVDH output terminal of the step-up circuit 1 12D is connected to the reference voltage (GND) terminal in the power circuit 120 via a resistive element during a period T1. Thereafter, after the voltage DDVDH has a value equal to or smaller than a first voltage value at a time instant t2 (period T2), the voltage DDVDH output terminal of the step-up circuit 1 12D is connected directly to the voltage Vcc input terminal of the power circuit 120.

Moreover, when the step-up circuit 2 12F stops at the time instant t1, the voltage VGH output terminal of the step-up circuit 2 12F is connected to the reference voltage (GND) terminal in the power circuit 120 via a resistive element. Thereafter, after the voltage VGH has a value equal to or smaller than a second voltage value at a time instant t3 (period T4), the voltage VGH output terminal of the step-up circuit 2 12F is connected directly to the voltage DDVDH output terminal of the step-up circuit 1 12D.

Consequently, in the present embodiment, when the power supply is turned off, an amount of charge flowing from the step-up circuit to the external input voltage Vcc terminal can be minimized to be approximately a one-tenth ( 1/10).

Concrete components needed to implement the off sequence in the liquid crystal display module in accordance with the present embodiment will be described below.

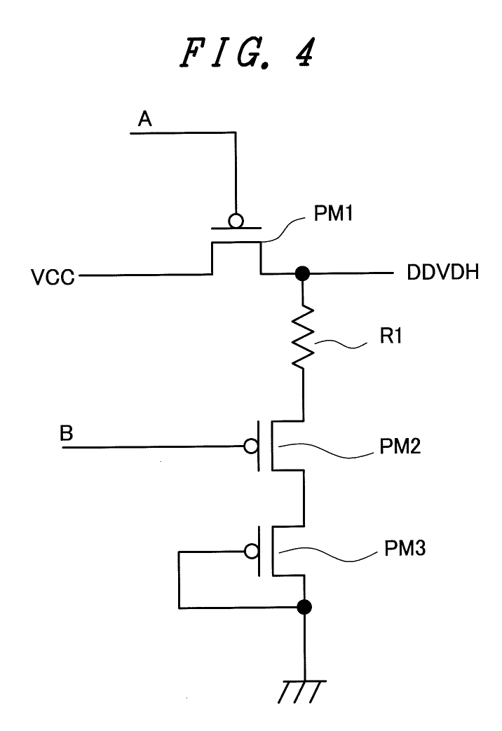

FIG. 4 is a circuit diagram showing the circuitry for releasing the voltage DDVDH.

In the present embodiment, a p-type MOS transistor (hereinafter a PMOS) PM2 is turned on responsively to a control signal B during the period T1 shown in FIG. 3. The voltage DDVDH output terminal of the step-up circuit 1 12D is connected to the reference voltage (GND) terminal in the power circuit 120 via a resistive element R1 and a diode-connected PMOS PM3. The voltage DDVDH is released to the reference voltage GND terminal. During the period T1, a PMOS PM1 remains off.

During the period T2 shown in FIG. 3, the PMOS PM1 is turned on responsively to a control signal A. The voltage DDVDH output terminal of the step-up circuit 1 12D is connected directly to the voltage Vcc input terminal of the power circuit 120. The voltage DDVDH is released to the voltage Vcc input terminal. During the period T2, a PMOS PM2 remains off.

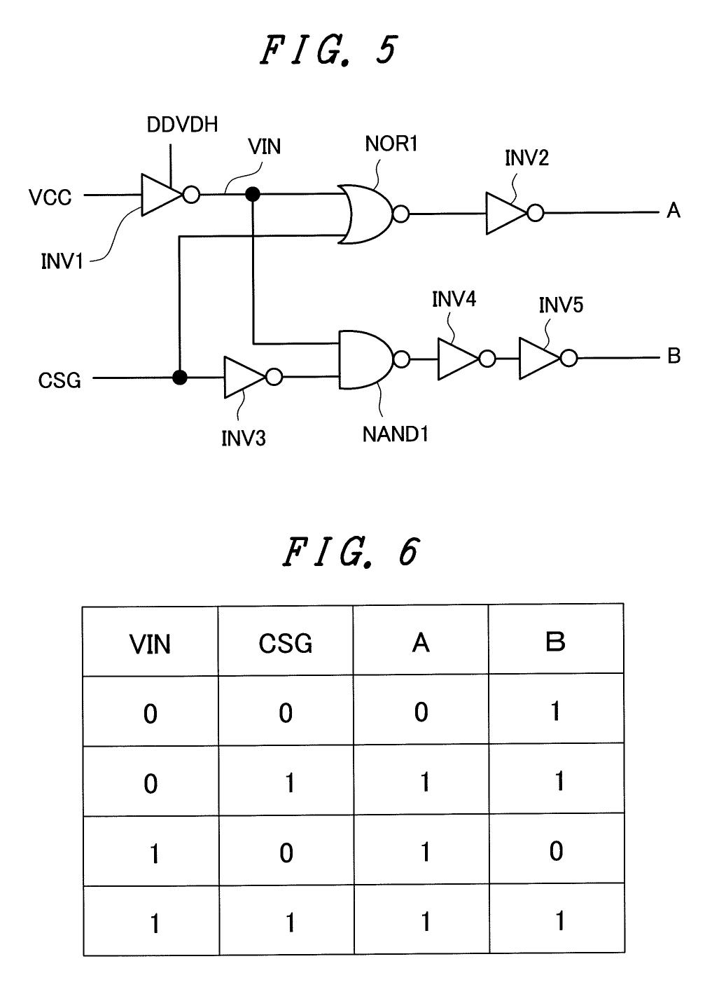

FIG. 5 is a circuit diagram showing the circuitry for generating the control signal A and control signal B shown in FIG. 4. FIG. 6 shows a truth table relevant to the circuit shown in FIG. 5. In FIG. 5, reference symbol NAND1 denotes a NAND circuit, NOR1 denotes a NOR circuit, and INV1 to INV5 denote inverters.

In FIG. 5, reference symbol CSG denotes a control signal. The control signal CSG is normally high, that is, normally has a high level. When the step-up circuit 1 12D and step-up circuit 2 12F stop, the control signal goes low, that is, changes the levels thereof from the high level to a low level.

Since the voltage Vcc is a voltage of approximately 3 V and the voltage DDVDH is a voltage of approximately 5.5 V, the output VIN of the inverter INV1 is normally high. When the voltage DDVDH becomes equal to or smaller than a value Vcc+Vth, the output VIN of the inverter INV1 goes low. Incidentally, reference symbol Vth denotes a threshold voltage of a transistor included in the inverter INV1.

Consequently, as shown in FIG. 6, when the control signal CSG is low and the voltage DDVDH is a voltage equal to or larger than the value Vcc+Vth, the output VIN of the inverter INV1 goes high, that is, changes the levels thereof from the low level to the high level. This causes the control signal A to go high and the control signal B to go low. Eventually, the PMOS PM1 shown in FIG. 4 is turned off and the PMOS PM2 shown therein is turned on.

Moreover, when the control signal CSG is low and the voltage DDVDH is a voltage equal to or smaller than the value Vcc+Vth, the output VIN of the inverter INV1 goes low. This causes the control signal A to go low and the control signal B to go high. Eventually, the PMOS PM1 shown in FIG. 4 is turned on and the PMOS PM2 shown therein is turned off.

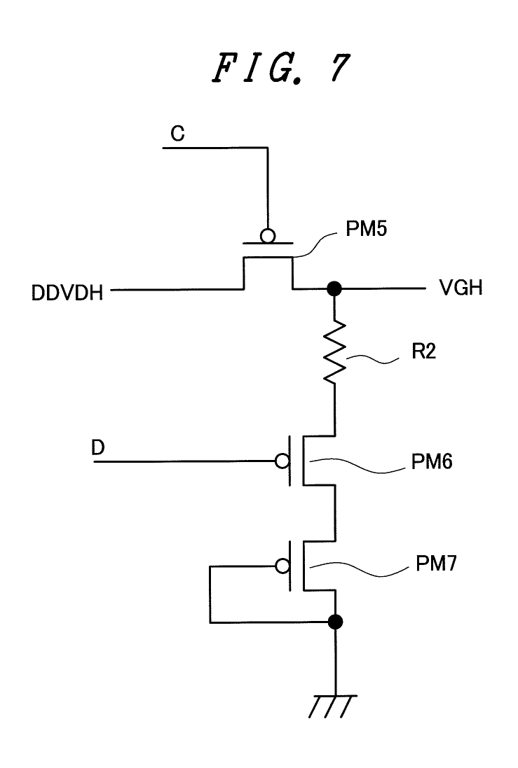

FIG. 7 is a circuit diagram showing the circuitry for releasing the voltage VGH.

In the present embodiment, a PMOS PM6 is turned on responsively to a control signal D during the period T3 shown in FIG. 3. The voltage VGH output terminal of the step-up circuit 2 12F is connected to the reference voltage (GND) terminal in the power circuit 120 via a resistive element R2 and a diode-connected PMOS PM7. The voltage VGH is released to the reference voltage GND terminal. During the period T3, a PMOS PM5 remains off.

During the period T4 shown in FIG. 3, the PMOS PM5 is turned on responsively to a control signal C. The voltage VGH output terminal of the step-up circuit 2 12F is connected directly to the voltage DDVDH output terminal of the step-up circuit 1 12D. The voltage VGH is released to the voltage Vcc terminal. During the period T4, a PMOS PM6 remains off.

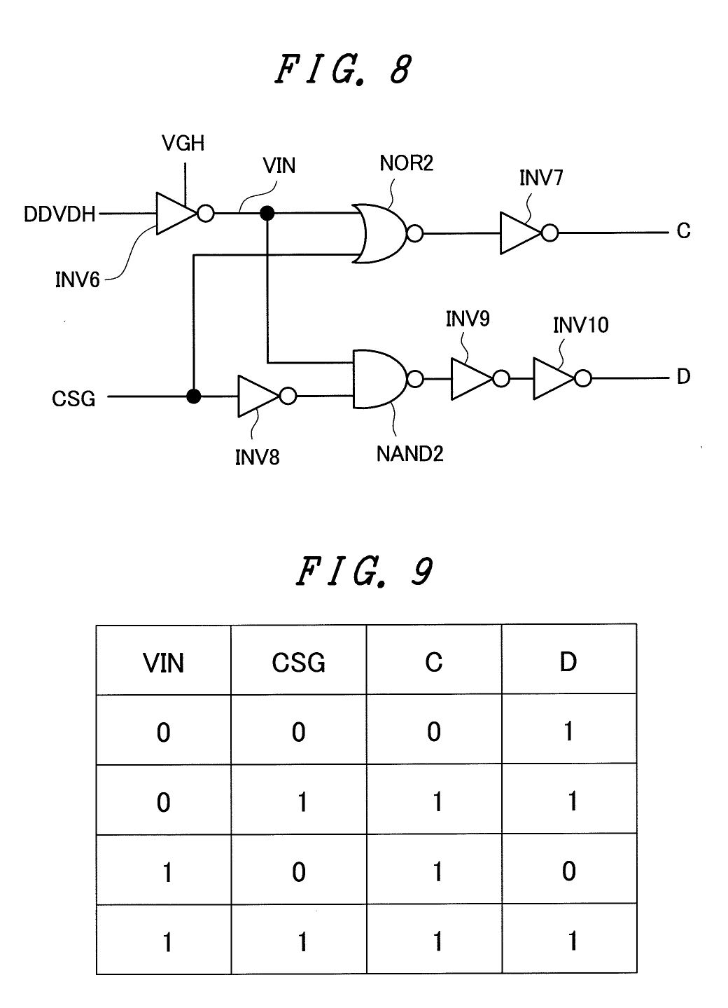

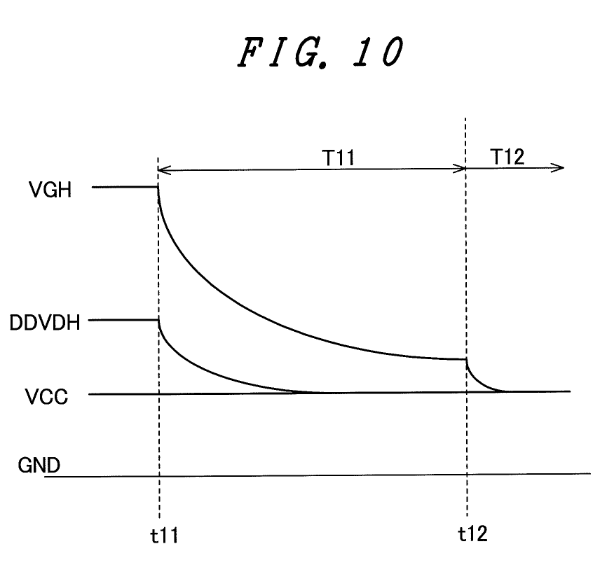

FIG. 8 is a circuit diagram showing the circuitry for generating the control signal C and control signal D shown in FIG. 7. FIG. 9 shows a truth table relevant to the circuit shown in FIG. 8. In FIG. 8, reference symbol NAND2 denotes a NAND circuit, NOR2 denotes a NOR circuit, and INV5 to INV10 denote inverters.

In FIG. 8, the voltage DDVDH is a voltage of approximately 5.5 V and the voltage VGH is a voltage of approximately 13 V. The output VIN of the inverter INV6 is normally high, that is, normally have a high level. When the voltage VGH becomes equal to or smaller than a value DDVDH+Vth, the output VIN of the inverter INV6 goes low, that is, changes the levels thereof from the high level to a low level. Incidentally, reference symbol Vth denotes a threshold voltage of a transistor included in the inverter INV6.

As shown in FIG. 9, when the control signal CSG is low and the voltage VGH is a voltage equal to or larger than the value DDVDH+Vth, the output VIN of the inverter INV6 goes high, that is, changes the levels thereof from the low level to the high level. This causes the control signal C to go high and the control signal D to go low. The PMOS PM5 in FIG. 7 is turned off and the PMOS PM6 shown therein is turned on.

Moreover, when the control signal CSG is low and the voltage VGH is a voltage equal to or smaller than the value DDVDH+Vth, the output VIN of the inverter INV1 goes low. This causes the control signal C to go low and the control signal D to go high. Consequently, the PMOS PM5 shown in FIG. 7 is turned on and the PMOS PM6 shown therein is turned off.

The embodiment in which the present invention is applied to a liquid crystal display module has been described so far. The present invention is not limited to the liquid crystal display module. Needless to say, the present invention can be applied to any other type of display device in which a power circuit is incorporated.

The invention made by the present inventor has been concretely described based on the embodiment. The present invention is not limited to the embodiment but can be modified in various manners without a departure from the gist.

What is claimed is:

1. A display device comprising:
a display panel; and
a drive circuit that drives pixels included in the display panel, wherein:
the drive circuit includes a power circuit to which a voltage Vcc is fed; and
the power circuit includes: a first step-up circuit that generates a voltage DDVDH which is higher than the voltage Vcc;
a means 1 that when the first step-up circuit is de-energized, connects the voltage DDVDH output terminal of the first step-up circuit to a reference voltage terminal via a resistive element during a first period; and a means 2 that connects the voltage DDVDH output terminal of the first step-up circuit to an input terminal, to which the voltage Vcc is fed, during a second period succeeding the first period.

2. The display device according to claim 1, wherein:
the means 1 is a first transistor that is turned on responsively to a control signal B and that connects the voltage DDVDH output terminal of the first step-up circuit to the reference voltage terminal via a resistive element; and
the means 2 is a second transistor that is turned on responsively to a control signal A and that connects the voltage DDVDH output terminal of the first step-up circuit to the input terminal to which the voltage Vcc is fed.

3. The display device according to claim 2, wherein:
the control signal A and control signal B are outputs of a logic circuit to which the voltage DDVDH, voltage Vcc, and a signal with which starting or stopping the display device is controlled are fed;
the control signal B is a signal with which when the display device is stopped and the voltage DDVDH has a value larger than a first voltage value, the first transistor is turned on; and
the control signal A is a signal with which when the display device is stopped and the voltage DDVDH has a value equal to or smaller than the first voltage value, the second transistor is turned on.

4. The display device according to claim 1, wherein the power circuit includes:
a second step-up circuit that generates a voltage VGH which is higher than the voltage DDVDH;
a means 3 that when the step-up circuit is de-energized, connects the voltage VGH output terminal of the second step-up circuit to the reference voltage terminal via a resistive element during the first period; and
a means 4 that connects the voltage VGH output terminal of the second step-up circuit to the voltage DDVDH output terminal of the first step-up circuit during the second period succeeding the first period.

5. The display device according to claim 4, wherein:
the means 3 is a third transistor that is turned on responsively to a control signal D and that connects the voltage VGH output terminal of the second step-up circuit to the reference voltage terminal via a resistive element; and
the means 4 is a fourth transistor that is turned on responsively to a control signal C and that connects the voltage VGH output terminal of the second step-up circuit to the voltage DDVDH output terminal of the first step-up circuit.

6. The display device according to claim 5, wherein:
the control signal D and control signal C are outputs of a logic circuit to which the voltage VGH, voltage DDVDH, and a signal with which starting or stopping the display device is controlled are fed;
the control signal D is a signal with which when the display device is stopped and the voltage VGH has a value larger than a second voltage value, the third transistor is turned on; and
the control signal C is a signal with which when the display device is stopped and the voltage VGH has a value equal to or smaller than the second voltage value, the second transistor is turned on.

7. The display device according to claim 1, wherein the display device is a liquid crystal display device, and the display panel is a liquid crystal display panel.
